(19) United States
(12) Patent Application Publication
(10) Pub. No.: US 2026/0312527 A1
(43) Pub. Date: Oct. 8, 2026

(54) SYSTEMS AND METHODS FOR SOLAR POWER AND VOLTAGE DENSITY

(71) Applicant: Aleksandar MILOJKOVIC, Vancouver (CA)

(72) Inventor: Aleksandar MILOJKOVIC, Vancouver (CA)

(21) Appl. No.: 19/147,194

(22) PCT Filed: Dec. 13, 2023
(86) PCT No.: PCT/CA2023/051654

§ 371 Date: Jul. 10, 2025

(30) Foreign Application Priority Data
Feb. 14, 2022 (CA) 3184019
May 17, 2023 (CA) 3201382

(51) Int. Cl. H02S 20/10; H02S 40/22; H02S 40/30; H02S 40/42

(52) U.S. Cl. CPC H02S 20/10; H02S 40/22; H02S 40/30; H02S 40/42

(57) ABSTRACT

A solar panel tower, the tower comprising: a first level of one or more bifacial solar panels arranged to form one or more sides of a first polygon around a longitudinal axis, wherein a first face of each of the first level of bifacial solar panels forms one side of the first polygon; and a second level of bifacial solar panels arranged to form one or more sides of a second polygon around the longitudinal axis and longitudinally spaced along the longitudinal axis from the first level of bifacial solar panels, wherein a first face of each of the second level of bifacial solar panels forms one side of the second polygon.

### CROSS-REFERENCE TO RELATED APPLICATIONS

This application claims priority from Canadian application No. 3184019, filed 14 Dec. 2022, and Canadian application No. 3201382, filed 17 May 2023. For purposes of the United States, this application claims the benefit under 35 U.S.C. § 119 of application Canadian application No. 3184019, filed 14 Dec. 2022 and entitled SYSTEMS AND METHODS FOR SOLAR POWER AND VOLTAGE DENSITY, and Canadian application No. 3201382, filed 17 May 2023 and entitled SYSTEMS AND METHODS FOR SOLAR POWER AND VOLTAGE DENSITY both of which are hereby incorporated herein by reference for all purposes.

### TECHNICAL FIELD

The present invention relates to the collection of solar energy to produce electricity. More specifically, the invention relates to bifacial solar panels arranged in vertical tower geometries.

### BACKGROUND

Although the harnessing of the visible and invisible spectra of the sun's rays to create electricity has had some success at reducing carbon equivalent emissions, conventional solar panel systems are still subject to 2-dimensional limitations in terms of surface power density when compared to fossil fuel power plants. In order to further improve solar power and make it a more viable alternative to fossil fuels, significant further gains in the yield of solar power density need to be made.

Although technological progress is improving solar cell efficiency and lowering production costs, in many situations, the amount of power that can be generated is limited by direct light from the sun received by a single sided solar panel surface. For example, the available area of a rooftop or a parking lot may limit the quantity of solar panels that can be installed. The ability to utilize a scalable third dimension (height) would therefore be of value for improving solar power density.

Solar panels are DC power sources that may be connected in series, like household batteries, to create high DC circuit voltages. Higher voltages can be used to transfer electrical power more efficiently using smaller wire sizes, like overhead power lines. The ability to adaptively increase both solar power density and solar circuit voltage vertically would be advantageous for a variety of high power DC and AC circuit applications with zero fossil fuel combustion emissions.

### SUMMARY

The present invention provides for a system of one or more volumetric solar towers that can enhance the solar output density for a volume using bifacial solar panels. Bifacial solar panels are an improvement to monofacial solar panels as they may collect solar energy from both the front and back panel sides for combined conversion into electricity. The ability to collect solar energy from both front and back sides of panels increases both the collection area and the geometric opportunities to capture indirect solar energy.

In one embodiment, the present disclosure is directed to a system for converting solar energy into electricity for a specified sky volume over a period of time. The system comprises one or more solar tower geometries comprising: bifacial solar panels, two or more solar panel tower sides, two or more solar panel tower levels, the solar panels having both front and back (bifacial) solar collection surface areas, and the solar panels having electrical connectivity as one or more combinations of DC power circuits.

One aspect of the present invention provides a solar panel tower, the tower comprising: a first level of one or more bifacial solar panels arranged to form one or more sides of a first polygon around a longitudinal axis, wherein a first face of each of the first level of bifacial solar panels forms one side of the first polygon; and a second level of bifacial solar panels arranged to form one or more sides of a second polygon around the longitudinal axis and longitudinally spaced along the longitudinal axis from the first level of bifacial solar panels, wherein a first face of each of the second level of bifacial solar panels forms one side of the second polygon.

In one or more embodiments of the present invention:
the first polygon has a number of sides equal to or greater than a number of sides of the second polygon;
the second polygon has a number of sides equal to or less than a number of sides of the first polygon;
the number of bifacial solar panels in the first level is equal to the number of sides of the first polygon;
the number of bifacial solar panels in the second level is equal to the number of sides of the second polygon;
the number of bifacial solar panels in the third level is equal to the number of sides of the third polygon;
the longitudinal axis is substantially vertical;
the first polygon is a first regular polygon and the second polygon is a second regular polygon;
the first polygon is a first regular polygon, the second polygon is a second regular polygon; and the third polygon is a third regular polygon;
the first polygon is one of: a triangle, a square, a rectangle, a pentagon, a hexagon, a heptagon, an octagon, a nonagon, and a decagon;
the second level of bifacial solar panels is longitudinally spaced along the longitudinal axis from the first level of bifacial solar panels by a level gap;
the first face of each of the first level and the second level of bifacial solar panels has a panel height parallel to the longitudinal axis, and the level gap is greater than the panel height;
the sides of the first polygon are substantially parallel with the sides of the second polygon; and/or
the sides of the first polygon are at an angle to the sides of the second polygon.

Some embodiments of the present invention comprise a third level of bifacial solar panels arranged to form one or more sides of a third polygon around the longitudinal axis and longitudinally spaced along the longitudinal axis from the second level of bifacial solar panels, wherein a first face of each of the third level of bifacial solar panels forms one side of the third polygon. In some embodiments, the third polygon has a number of sides equal to, greater than, or less than a number of sides of the second polygon.

Some embodiments of the present invention comprise one or more mirrors, wherein a reflective surface of each of the mirrors forms one of the sides of one of: the first polygon and the second polygon. Some embodiments of the present invention further comprise one or more mirrors configured to reflect sunlight on to one or more of: one or more of the first level of bifacial solar panels and one or more of the second level of bifacial solar panels.

### BRIEF DESCRIPTION OF THE DRAWINGS

For the purposes of illustrating the invention, the drawings show aspects of one or more embodiments of the invention. However, it should be understood that the present invention is not limited to the precise arrangements and instrumentalities shown in the drawings.

FIG. 1A is a representation view of a prior art monofacial solar panel on a flat surface.

FIG. 1B is a perspective view of a prior art monofacial solar panel array on a flat surface.

FIG. 1C is a top view of a prior art monofacial solar panel array on a flat surface.

FIG. 2A is a representation view of a prior art bifacial solar panel tilted above a flat surface.

FIG. 2B is a perspective view of a prior art bifacial solar panel array tilted above a flat surface.

FIG. 2C is a top view of a prior art bifacial solar panel array tilted above a flat surface.

FIG. 3A is a perspective view of a bifacial solar panel tower according to an example embodiment of the present invention.

FIG. 3B is a perspective light ray trace view of a bifacial solar panel tower according to the example embodiment depicted in FIG. 3A.

FIG. 3C is a top view of a bifacial solar panel tower according to the example embodiment depicted in FIG. 3A.

FIG. 4A is perspective view of a bifacial solar panel tower array according to an example embodiment of the present invention.

FIG. 4B is perspective view of a bifacial solar panel tower array with two mirror surfaces according to an example embodiment of the present invention.

FIG. 4C is perspective view of a bifacial solar panel tower in an array with three mirror surfaces according to an example embodiment of the present invention.

FIG. 5 is a schematic diagram of the solar power relationship between the sun, the solar panel tower, solar panel front and back side power, and mirror surfaces, according to an example embodiment of the present invention.

FIG. 6 is an electrical schematic diagram of a solar panel tower powering an AC Load according to an example embodiment of the present invention.

FIG. 7 is an electrical schematic diagram of a solar panel tower powering an AC Load with a DC Chemical Battery and a DC Charger, according to an example embodiment of the present invention.

FIG. 8 is an electrical schematic diagram of a solar panel tower powering a DC Load according to an example embodiment of the present invention.

FIG. 9 is an electrical schematic diagram of a solar panel tower powering a DC Load with a DC Chemical Battery and a DC Charger, according to an example embodiment of the present invention.

FIG. 10 is an electrical energy schematic diagram of a solar panel tower powering a resistor which outputs thermal energy into a hot thermal battery connected to a heat pump system, according to an example embodiment of the present invention.

FIG. 11 is an electrical energy schematic diagram of a solar panel tower powering a resistor which outputs thermal energy into a thermal hot battery connected to a steam engine system or a Rankine cycle system to generate electricity, according to an example embodiment of the present invention.

FIG. 12 is an electrical energy schematic diagram of a solar panel tower powering a DC thermoelectric system which exchanges thermal energy with hot and cold thermal batteries, geothermal storage, hydrocarbon storage and a Carnot engine system, according to an example embodiment of the present invention.

FIG. 13 is an electrical energy schematic diagram of a solar panel tower powering a DC electrolysis system which may input chemical compounds and output chemical elements, according to an example embodiment of the present invention.

FIG. 14 is an electrical energy schematic diagram of a solar panel tower powering a DC electrolysis system which may input chemical compounds like water and output elements like oxygen and hydrogen, according to an example embodiment of the present invention.

FIG. 15 is an electrical energy schematic diagram of a solar panel tower powering a DC Electrolysis system which may input elements and output chemical compounds, according to an example embodiment of the present invention.

FIG. 16 is an electrical energy schematic diagram of a solar panel tower powering a DC electrolysis system which may input elements and output chemical compounds, according to an example embodiment of the present invention.

FIG. 17A-1 is a color perspective view of two solar panel towers in an array receiving solar energy directly from the sun, according to an example embodiment of the present invention. FIG. 17A-2 is a greyscale version of the view depicted in FIG. 17A-1.

FIG. 17B-1 is a color perspective view of two solar panel towers in an array receiving reflected solar energy from the sun, according to an example embodiment of the present invention. FIG. 17B-2 is a greyscale version of the view depicted in FIG. 17B-1.

FIG. 17C-1 is a color perspective view of ten solar panel towers in an array receiving solar energy directly from the sun, according to an example embodiment of the present invention. FIG. 17C-2 is a greyscale version of the view depicted in FIG. 17C-1.

FIG. 17D-1 is a color perspective view of ten solar panel towers in an array receiving reflected solar energy from the sun, according to an example embodiment of the present invention. FIG. 17D-2 is a greyscale version of the view depicted in FIG. 17D-1.

### DETAILED DESCRIPTION

Throughout the following description specific details are set forth in order to provide a more thorough understanding to persons skilled in the art. However, well known elements may not have been shown or described in detail to avoid unnecessarily obscuring the disclosure. Accordingly, the description and drawings are to be regarded in an illustrative, rather than a restrictive, sense.

The global climate change crisis requires the rapid de-carbonization of power and energy systems used by humans on Earth. This means that fossil fuels can no longer be burned to release thermal energy for the production of electricity or heat in buildings or vehicles. The size, scale and speed of the global energy transition is unprecedented and requires fundamental improvements in solar power density and DC power network applications.

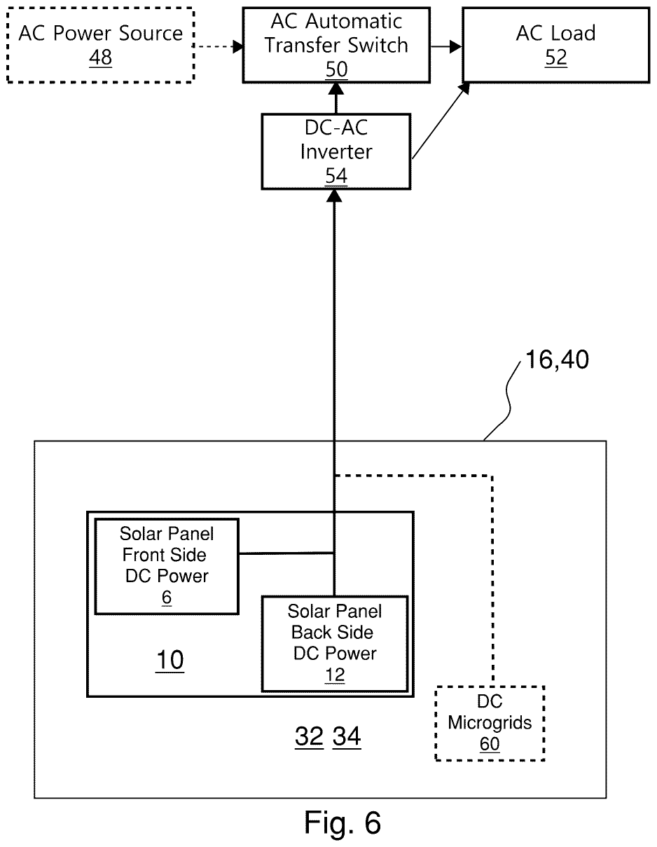

The present invention provides for a solar panel tower geometry that can provide improved solar power density using bifacial solar panels. Bifacial solar panels are an improvement to monofacial solar panels as they may collect solar energy from both the front and back sides of a solar panel. Collecting solar energy from both the front and back sides of a solar panel can increase the electrical power yielded throughout the day. Solar panels may be electrically connected in series, like household batteries, to increase DC circuit voltages. Higher circuit voltages can be used to transfer more electrical power with less resistance, utilizing smaller wire conductor sizes. The ability to vertically increase both solar power density and voltage density would be advantageous for a variety of DC and AC power and energy applications (see FIGS. 6 to 16).

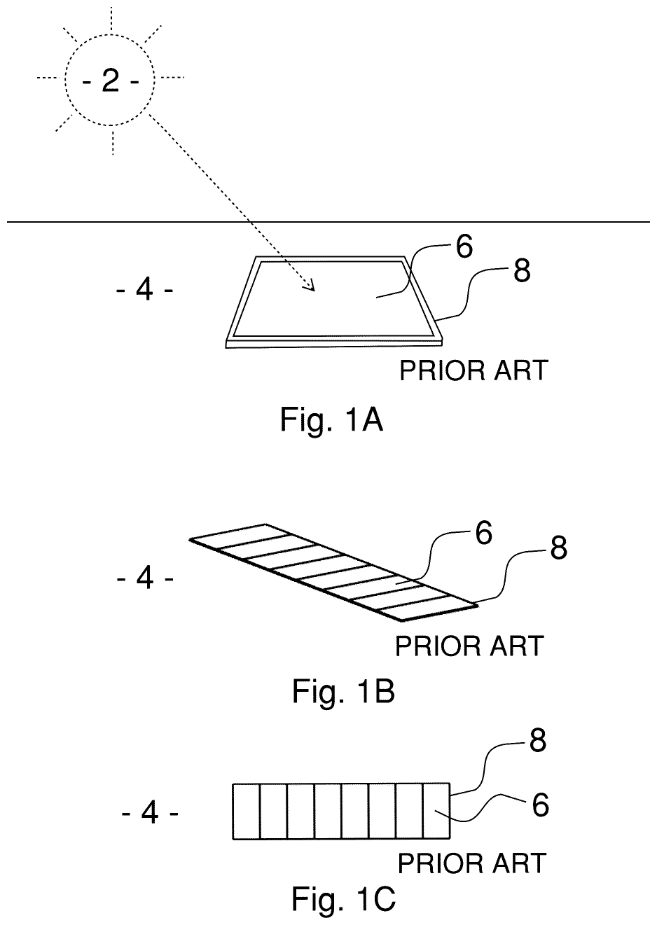

FIG. 1A depicts a photovoltaic system comprising a single monofacial panel 8 consisting of front side photovoltaic cells 6. The photovoltaic panel 8 may be laid flat on a terrestrial surface 4 such as earth or a roof top. Such a system is fixed in that the solar panel 8 is stationary and the sun 2 moves overhead at a changing angle. The back side (not shown) of a monofacial solar panel 8 is completely opaque and does not collect any solar energy.

FIGS. 1B and 1C depict a plurality of monofacial solar panels 8 connected in series arrays. Connecting solar panels in series may increase the voltage of the DC circuit proportionally while maintaining the same current. In a flat surface installation, the amount of DC power and voltage that can be generated on a terrestrial surface 4 is limited to the front side photovoltaic cells 6. Examples of terrestrial surfaces 4 for solar panel 8 flat installation may include: rooftops, building walls, parking lots or floating structures.

In an installation of monofacial solar panels 8, the time available for direct solar power collection from the sun 2 may be further limited by morning and evening angles of solar incidence which results in less daily solar power production on the terrestrial surface 4.

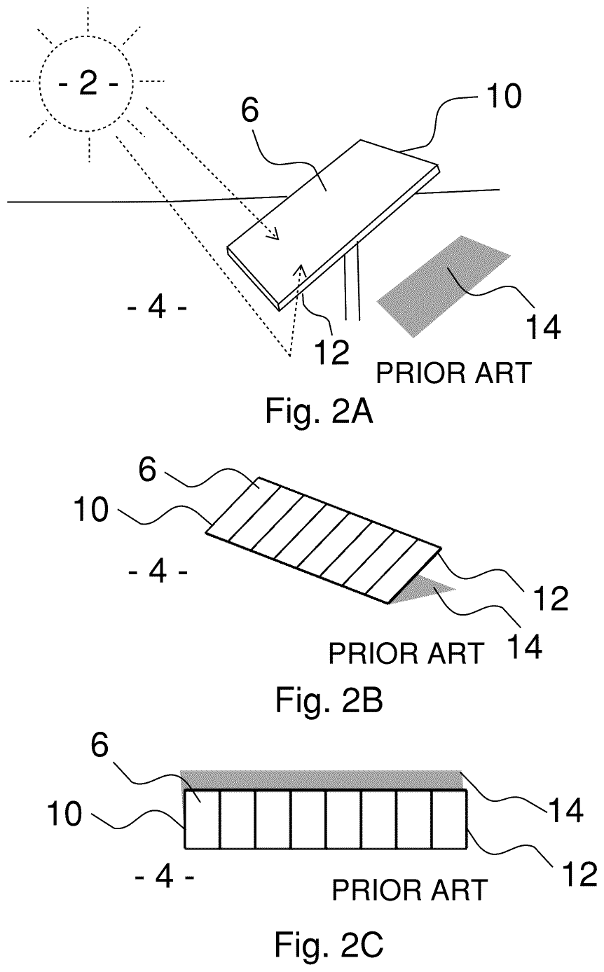

FIG. 2A depicts a bifacial solar panel 10, elevated and tilted towards the sun 2. Tilting and directing the front side photovoltaic cells 6 towards the sun 2 can both improve the front side incidence angle and increase the amount of daily power generated by a solar panel 10.

As an improvement to monofacial panels 8, a bifacial solar panel 10 can collect solar energy from both front side 6 and back side 12 areas. A bifacial solar panel 10 power output may be a continuous sum of the combined front side 6 power and back side 12 power.

Raising and tilting a solar panel 10 towards the sun may cast a shadow 14 onto a terrestrial surface 4. The shadow 14 created on a terrestrial surface 4 may reduce the amount of surface reflected light that can be collected on the backside 12 photovoltaic cells for conversion into power.

Bifacial solar panels 10 are typically installed in series arrays with front side 6 tilted towards the sun as shown in FIGS. 2B and 2C. Shadows 14 may be compounded when solar panels 10 are installed in tilted series arrays as shown in FIGS. 2B and 2C with continuous surface shadows 14 throughout the day. Continuous shadows 14 may result in reduced power output of a bifacial solar array as part of a DC circuit.

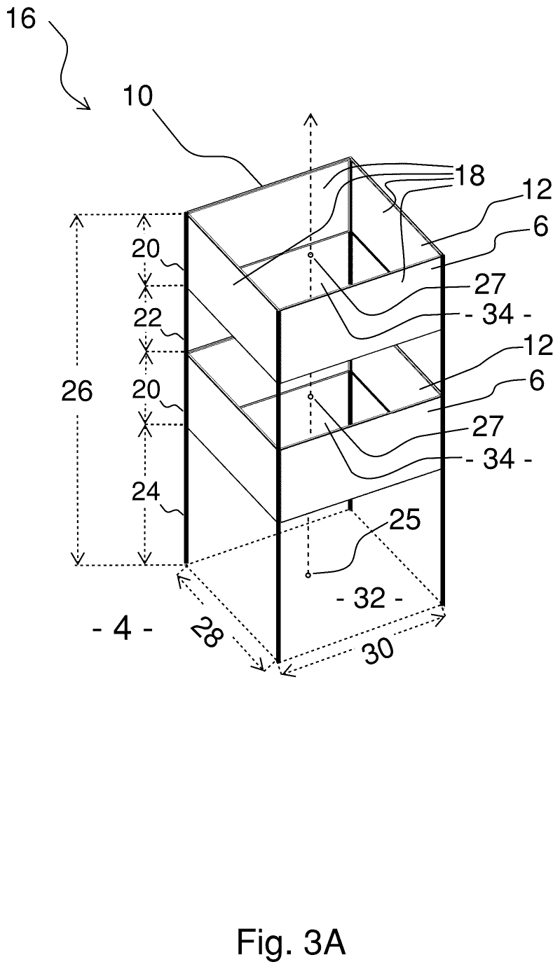

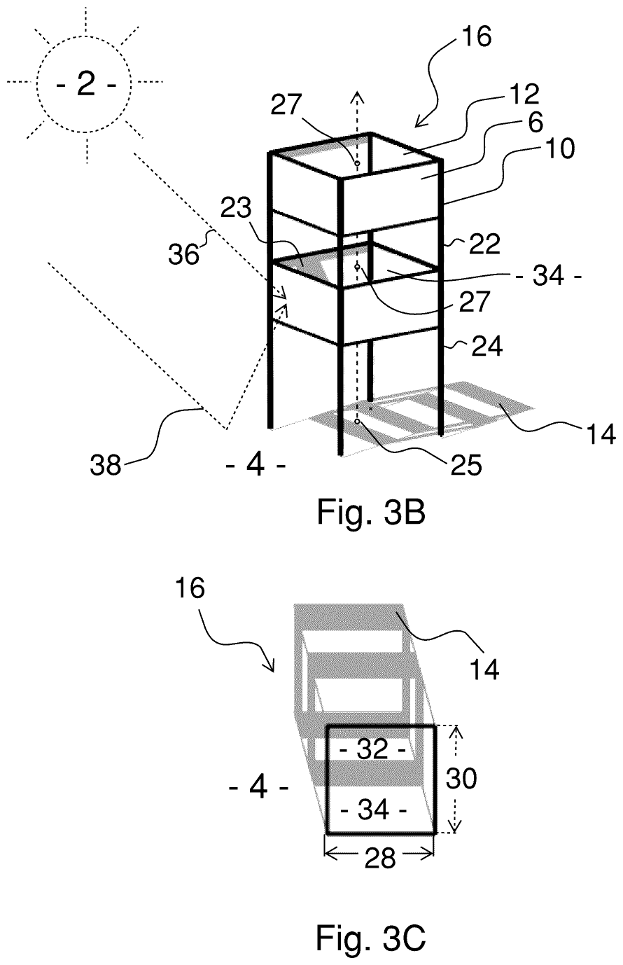

FIG. 3A is a perspective diagram of a solar panel tower 16 comprising a plurality of bifacial solar panels 10, according to an example embodiment of the present invention. Bifacial solar panels 10 are angled and positioned to collect solar energy directly from the sun and indirectly through passive reflection.

Solar panel tower 16 may comprise bifacial solar panels 10 aligned to form a 3-dimensional polygon geometry with four or more vertical sides 18 and two or more horizontal tower levels 20. The solar panel tower levels 20 may be supported by one or more support members, for example, one or more structural legs 24 and/or level spacing 22 supports. The bifacial solar panels 10 in each of levels 20 may be referred to as a set of bifacial solar panels.

FIG. 3A is a perspective view of solar panel tower 16 according to an example embodiment of the present invention. Solar panel tower 16 may have tower height 26, tower width 28, and tower length 30, wherein each of tower height 26, tower width 28, and tower length 30 are orthogonal to each other. Tower terrestrial surface area 32 may be a multiple of tower width 28 and tower length 30. Tower width 30 may be a multiple one or more solar panel 10 dimensions, like height or width. The tower length 30 may be a multiple of one or more solar panel 10 dimensions, like height or width. In some embodiments, solar panel tower 16 may have a tower volume 34 that is the product of tower width 28, tower length 30 and tower height 26.

In some embodiments of solar panel tower 16, tower volume 34 may be substantially hollow to enable direct and indirect light to reach the back sides 12 of solar panels 10. In some embodiments, tower volume 34 may be defined by one or more polygon geometries with one or more open sides.

In some embodiments, solar panel tower 16 can incorporate additional solar panels 10 by adding additional tower levels 20 vertically. Increasing the quantity of connected solar panel levels 20 vertically may increase the tower surface power density, surface voltage density and tower height 26. Adding one or more tower levels 20 vertically may not require an increase in the terrestrial surface area 4 utilized by the tower area 32.

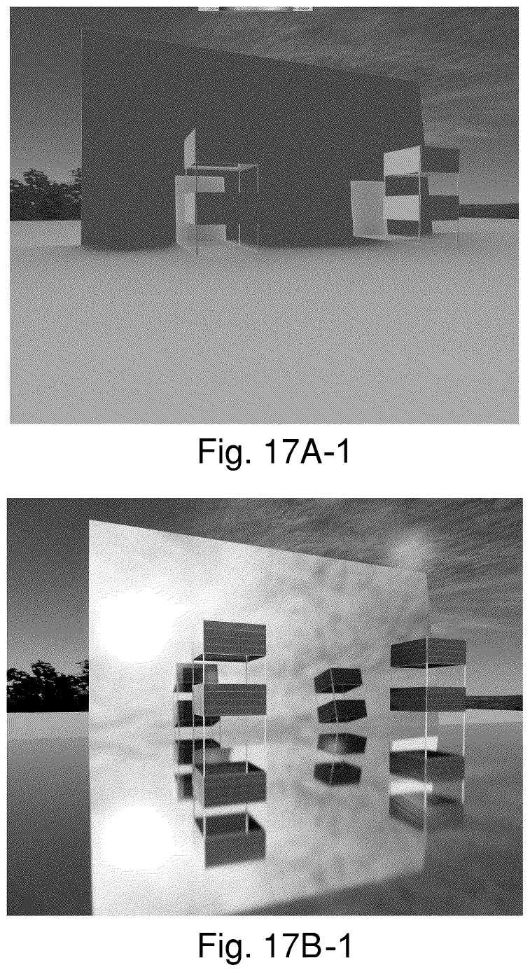

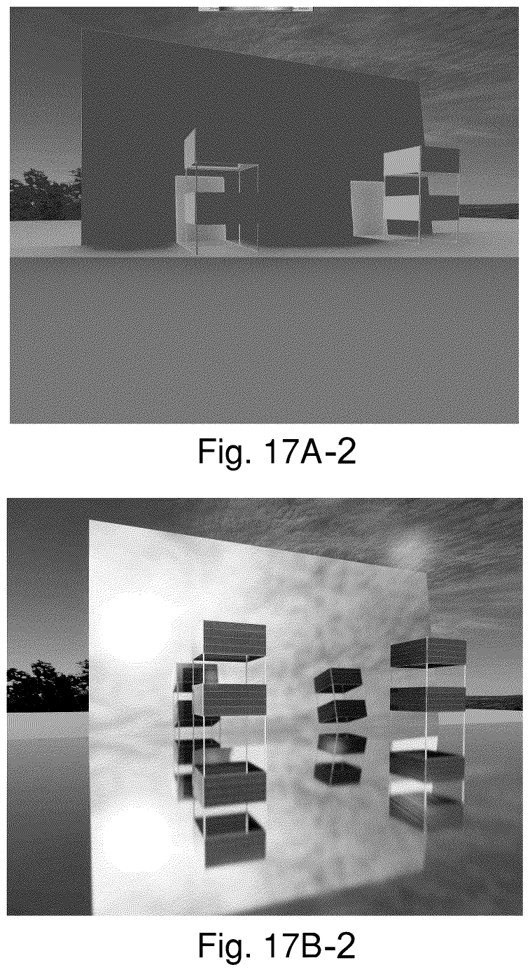

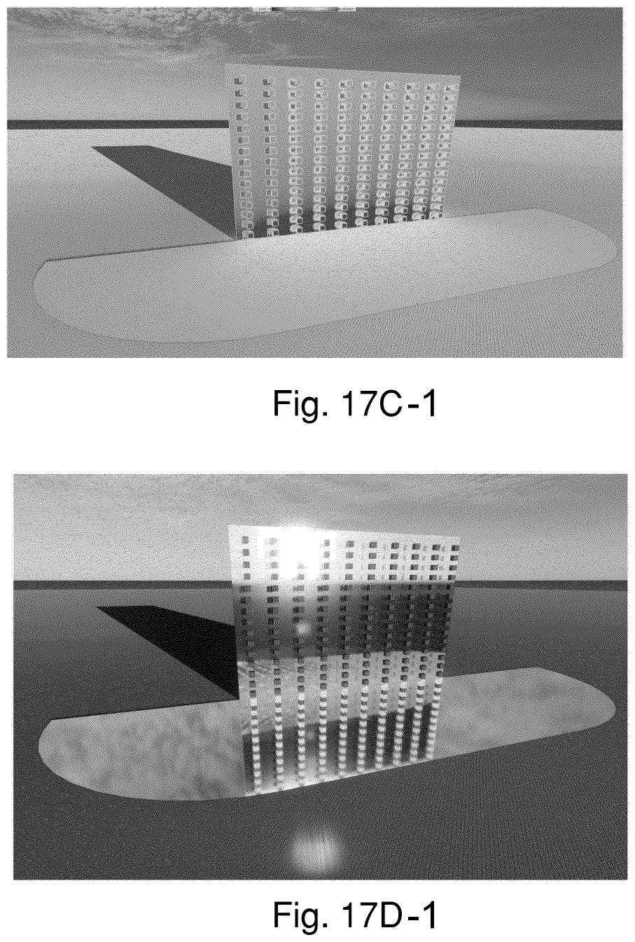

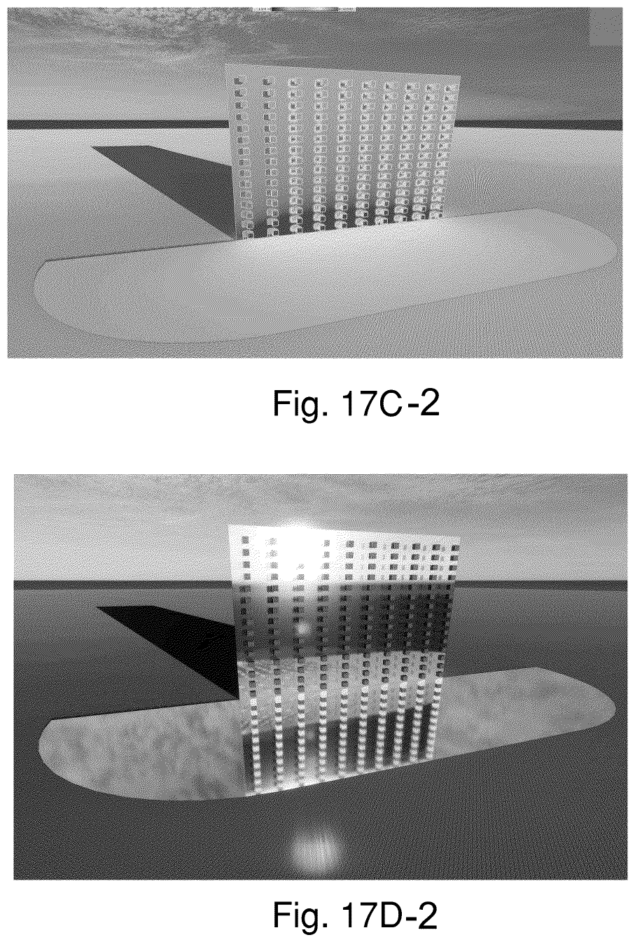

In some embodiments, tower height 26 is only limited by the structural integrity of the tower and the authority having jurisdiction. In some embodiments, tower height 26 is below a standard power or telecom utility pole height above grade, for example below 10 meters (32 feet). In some embodiments, the tower height 26 is less than a height where aviation safety visibility measures are required, for example below 61 meters (see FIG. 17A and 17B). In some embodiments, tower height 26 is below 609 meters (2000 feet) which is the height limit for a telecom radio tower in the United States.

In some embodiments, one or more solar panels 10 may be connected together by electrical cables (not shown) to form one or more series or parallel DC circuits within solar panel tower 16. The DC power and voltage circuit outputs of solar panel tower 16 can therefore be adjusted by electrically connecting or disconnecting solar panels 10 within solar panel tower 16, thereby obviating the need for alternating current (AC) transformers. Bypassing the limitations of AC power generation and transmission systems with vertically adjustable DC power and voltage circuits is one advantage of the solar panel tower 16 over conventional power plants.

In some embodiments, a solar panel tower 16 circuit voltage may not exceed the DC voltage rating of a solar panel 10. In some embodiments, for example when one or more tower levels 20 are added, a new DC circuit can be added on the solar panel tower 16 to balance and reduce the DC circuit voltage to not exceed the solar panel 10 voltage rating.

In some embodiments, the DC circuit voltage of the solar panel tower 16 may be adjusted to match current and future electric vehicle DC Fast Charging and battery standards. In some embodiments, solar panel tower 16 output circuit voltages may include one or more combinations of: 50 volts (V) DC, 100 V DC, 150 V DC, 200 V DC, 400 V DC, 800 V DC, 1000 V DC and 1500 V DC, and greater than 1500 V DC.

In some embodiments, the power, voltage and current output of solar panel tower 16 may be uncontrolled as DC circuits with direct wiring between solar panels 10.

In some embodiments, the power, voltage and current output of solar panel tower 16 may be controlled as DC circuits with semiconductor power transistors (not shown) between solar panels 10, for example one or more power transistors, like MOSFETs.

In some embodiments, a solar panel tower 16 may define one or more tower axis 25, 27. For example, solar panel tower 16 define a tower central axis 25, wherein the tower central axis extends from a center of tower base 32 normal to tower base 32, and therefore normal to terrestrial ground 4 where tower base 32 is parallel to terrestrial ground 4. Solar panel tower 16 may further define one or more tower levels 20 axes 27, wherein each of the tower level axes 27 is parallel to one or more of the solar panels in the respective one of tower levels 20, and is defined by a center of the respective one of tower levels 20.

In some embodiments, one or more tower levels 20 of solar panel tower 16 may be rotated or tilted relative to one or more others of tower levels 20. In some embodiments, solar panel tower 16 may include a step geometry (not shown) wherein the level axis 27 of one of tower levels 20 is offset horizontally from and/or angled relative to one or more level axes 27 of one or more other of tower levels 20. In some embodiments, the level axis 27 of each of tower levels 20 may be offset and/or rotated relative to the tower central axis 25.

In some embodiments, a solar panel tower 16 may include a support structure 24 (shown as dashed lines) to which bifacial solar panels 10 may be secured. Solar panel tower levels 20 may be supported or suspended by one or more legs 24. Legs 24 may extend from the terrestrial surface area 32 to the tower height 26 or above. In some embodiments, the geometry of legs 24 may be adjusted to minimize or eliminate disruptive impact to terrestrial surface area 4. In some embodiments, tower legs 24 may be tall enough to allow unimpeded passage underneath one of solar panel levels 20. In some embodiments, legs 24 may also minimize the quantity of contact points between the solar panel tower 16 and terrestrial surface area 4. In some embodiments, the minimal fixed contact points of legs 24 may make vertical installation much easier and faster compared to horizontal flat installation methods (see FIGS. 1A, 1B, and 1C) and tilted installation methods (see FIGS. 2A, 2B, and 2C).

In some embodiments, solar tower levels 20 may be supported such that solar tower legs 24 do not make contact with terrestrial surface area 4 below. In some embodiments, cantilevered or suspended solar tower legs 24 may reduce the requirement for solar tower 16 structural measures such as guy wires (not shown). In some embodiments, the side of a building facing towards the sun may be an installation location that is suitable for tower legs 24.

In some embodiments, legs 24 may connect the solar panel tower 16 to one or more artificial and/or natural support structures, for example: ground, earth, buildings, rooftops, pavement, roadways, walls, vehicles, vessels, ice and the like.

In some embodiments, legs 24 may be made of one or more of: a recyclable metal such as aluminum, a sustainable wood source like bamboo or other circular materials and the like. In some embodiments, the volume of legs 24 may be minimized to allow for maximum direct 36 and indirect solar ray pathways (see FIG. 3B) within the tower volume 34.

Referring to FIG. 3B, solar panel tower 16 can collect solar energy directly 36 from the sun 2 and indirect solar energy from reflection 38. The internal volume of tower 34 may be hollow and open for passing solar direct 36 and reflected 38 solar energies within. Increasing the volume of direct 36 and reflected light 38 that enters the tower volume 38 may increase the amount of electricity generated by the back side 12 of bifacial solar panels 10.

Referring to FIG. 3B, the volume of direct sunlight 36 entering the solar tower volume 34 may be adjusted based on the height of the level spacing 22 between solar panel levels 20. Level spacing 22 may be adjusted to reduce internal shading 23 created by higher solar panels 10 in solar panel tower 16 onto lower solar panels 10 in solar panel tower 16. With zero (none) level spacing 22, direct sunlight 2 can only enter the open top and bottom ends of solar panel tower 16 which results in much more internal shading 23 but may also reduce the tower height 26.

FIG. 3C is a top view of solar panel tower 16. Solar panel tower 16 may be viewed as an orthogonal shape from a top plan view. An orthogonal plan shape representing both area 32 and volume 34 may make 2-dimensional and 3-dimensional planning simpler for building plan or construction record drawings. In some embodiments, a solar panel tower 16 plan symbol may include calculated shadow 14 geometries for simplified planning of terrestrial surface 4 shading applications. In some embodiments, the shading 14 provided by the solar panel tower 16 may be applied within agro-voltaic applications to reduce the amount direct solar energy 36 reaching objects above the terrestrial surface 4 such as: crops (not shown) and water bodies (not shown).

In some embodiments, solar panel tower 16 may physically support fiber optic cabling (not shown), radio antennas (not shown) and the like.

In some embodiments, solar panel tower 16 may act as a mast radiator in which the metal structure itself is energized and functions as a radio antenna as part of a radio communication system (not shown).

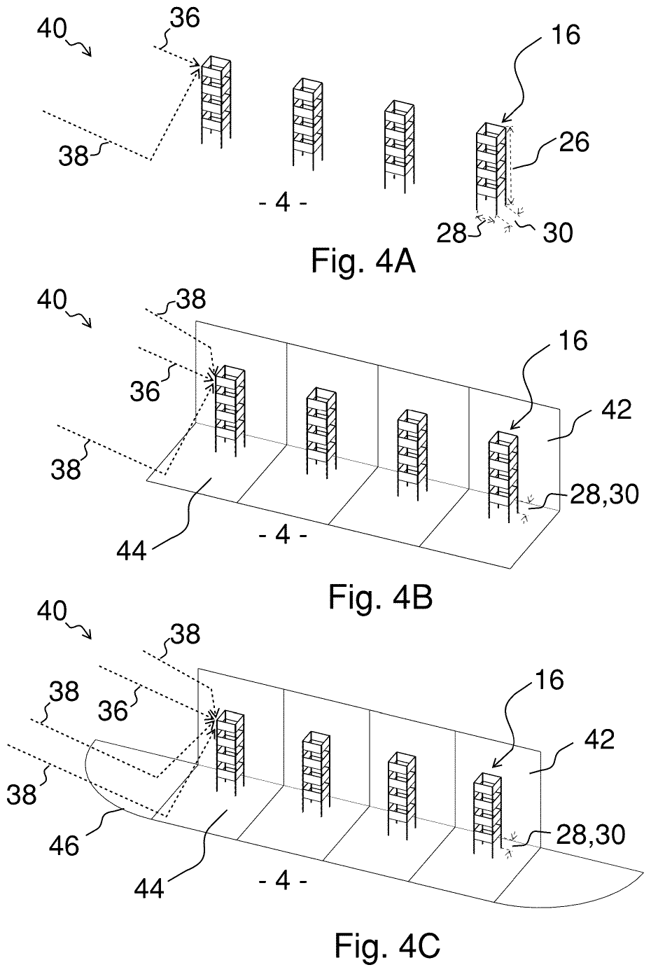

Referring to FIG. 4A, in some embodiments, one or more solar panel towers 16 may be grouped to form a solar tower array 40. Terrestrial surface 4 used by solar tower array 40 is equal to the sum of the tower areas 32 of the solar panel towers 16 comprising solar tower array 40. A solar tower array 40 can generate multiples of power per solar tower 16 over that which can be harvested by flat surface solar installations (see FIGS. 1A, 1B, and 1C) and tilted surface solar installations (see FIGS. 2A, 2B, and 2C).

In some embodiments, solar tower array 40 may be oriented so that the direct and passive properties of light are maximized for the production of electrical power based on the solar angles, location and season of terrestrial surface 4. Solar tower array 40 may minimize land use with increased solar yield with adaptable solar tower array 40 geometries.

The height of one or more solar tower arrays 40 may be the same as solar tower height 26. In some embodiments, multiple solar tower array 40 geometrical configurations and tower heights 26 can be adapted based on the amount of terrestrial surface area 4 and sky volume available.

In some embodiments, one or more solar towers 16 may be electrically connected by cables (not shown) to form one more DC circuits within or between one or more solar tower arrays 40.

Referring to FIGS. 4B and 4C, solar tower array 40 may further comprise one or more of: one or more standing mirrors 42, one or more base mirrors 44, and one or more adjunct mirrors 46. Mirrors 42, 44, 46 reflect solar energy onto solar panel tower 16, wherein path of the reflected solar energy is shown by lines 38. In some embodiments, for example where solar tower array 40 is installed in a location within the northern hemisphere, one or more of standing mirrors 42 may be on the northern side of solar tower array 40. In some embodiments, for example where solar tower array 40 is installed in a location within the southern hemisphere, one or more of standing mirrors 42 may be on the southern side of solar tower array 40. In some embodiments, standing mirrors 42 may be on one or more sides of the solar tower 16 including north, south, east and west facing sides of one or more levels 20 of solar tower 16. In some embodiments, mirrors 42, 44, 46 may reduce the local thermal heat island effect for adjunct urban, rural and natural land areas. In some embodiments, mirrors 42, 44, 46 may reduce global thermal irradiance.

In some embodiments, the width of standing mirrors 42 may repeat horizontally within solar tower array 40 as a multiple of tower width 28 to minimize horizontal shading between solar panel towers 16. In some embodiments, one or more of standing mirrors 42 may be installed on a vertical wall and/or structure 5. In some embodiments, solar panel tower 16 may be positioned one or more tower lengths 28 and/or tower widths 30 in front of standing mirrors 42 to minimize mirror shading (not shown). In some embodiments, the height of standing mirrors 42 may be greater than solar panel tower height 26 to reflect light downwards towards the solar panel towers 16. In some embodiments, one or more of standing mirrors 42 may be comprise a flat and/or curved surface made from circular and/or economical recycled materials like aluminium and glass. In some embodiments, standing mirrors 42 may comprise a reflective fabric material and/or tarpaulin that is suspended (not shown). In some embodiments, standing mirror 42 may be raised or lowered similar to a wind sail on a boat.

In some embodiments, one or more of base mirrors 44 may be installed underneath solar panel tower 16. In some embodiments, one or more base mirrors 44 may comprise a flat and/or curved reflective surface made from circular and/or economical recycled materials like aluminium and/or glass. In some embodiments, base mirrors 44 may comprise a reflective fabric material and/or tarpaulin that is suspended (not shown). In some embodiments, the base mirror 44 may be raised or lowered similar to a wind sail on a boat.

In some embodiments, one or more adjunct mirrors 46 may be installed adjacent to one or more of standing mirrors 42 and/or one or more of base mirrors 44 to provide additional area and degrees of radial reflection for the solar tower array 40. Adjunct mirrors 46 may increase the amount of radial reflection onto solar panel towers 16 from different sun positions throughout the day. In some embodiments, one or more adjunct mirrors 46 may comprise a flat and/or curved reflective surface made from circular and/or economical recycled materials like aluminium and/or glass. In some embodiments, adjunct mirrors 46 may comprise a reflective fabric material and/or tarpaulin that is suspended (not shown). In some embodiments, the adjunct mirrors 46 may be raised or lowered similar to a wind sail on a boat.

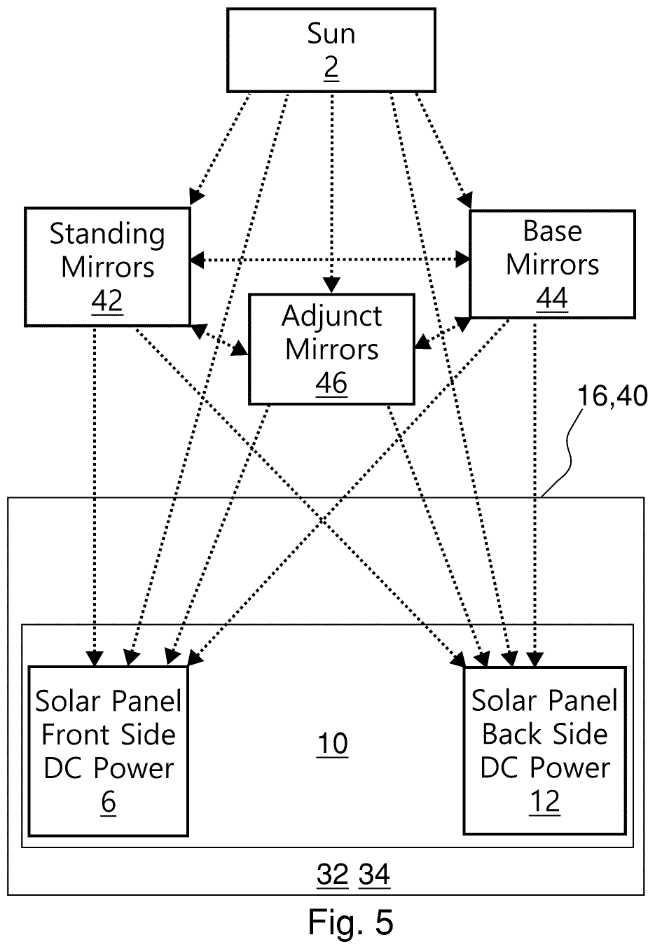

FIG. 5 is a schematic diagram of the possible relationships of direct and indirect solar reflection between one or more of: sun 2, mirrors 42, 44 and 46, and solar panel tower 16, within array 40. In some embodiments, the reflection relationships within array 40 may be passively or actively controlled to maximize a power output of solar panel tower 16, where the power output of solar panel tower 16 is the sum of the power output of front side 6 and the power output of back side 12. In some embodiments, mirrors 42, 44, 46 may be geometrically aligned with solar panel tower 16 to further increase the reflective solar power output gain.

In some embodiments, mirrors 42, 44, 46 may also provide radiative solar cooling. The solar cooling may be provided by mirrors 42, 44, 46 reflecting solar energy out toward the exosphere instead of on to solar panel tower 16. In some embodiments, the mirrors 42, 44, 46 may serve a dual purpose of amplifying solar tower 16 power yield and also radiative infrared cooling. Refer to MEER. org for applied sciences behind mirror reflectors for global solar thermal cooling applications.

In some embodiments, future improvements in bifacial solar panel 10 technology at the optical and electrical level can be incorporated more effectively into a solar panel tower 16 allowing for still greater improvements in solar power yield. In some embodiments, the front side 6 and back side 12 photovoltaic collector cells can be one or more semiconductor, silicon, perovskite, thin film, sheet, or fabric photovoltaic material. In some embodiments, the front 6 and back 12 side collection areas may comprise one or more separate photovoltaic cell materials. In some embodiments, one or more front 6 or back 12 side photovoltaic cells may be replaced over time without replacing the solar panel 10 frame.

FIG. 6 is an electrical energy diagram of one or more solar panel towers 16 in an array 40 powering an AC load 52 according to an example embodiment of the present invention. In some embodiments, solar panel tower 16 may contain one or more bifacial solar panels 10 with front 6 and back 12 collection surfaces generating power from a combination of direct and reflected solar power throughout the day. In some embodiments, solar panel tower 16 may also physically support DC microgrids 60 installed on the tower structure that share the same terrestrial tower area 32 and/or tower volume 34, for example wind and/or thermoelectric generators (not shown). In some embodiments, AC power source 48 may be an AC utility power source, like a utility AC power plant or AC transmission line. In some embodiments, the AC load 52 may be one or more combinations of resistors, capacitors, inductors, diodes or transistor nodes within an AC power network. In some embodiments, DC-AC inverter 54 transforms the solar panel tower 16 DC power into AC to directly power one or more AC load 52. In some embodiments, an AC automatic transfer switch 50 may instantaneously transfer power to the AC load 52 from more than one AC input. In some embodiments, an AC transfer switch 50 switches instantaneously between AC inputs in the event of power failure from either AC input source. In some embodiments, the addition of an AC transfer switch 50 improves the overall reliability of the power network supporting the AC load 52. In some embodiments, when a DC-AC inverter 54 is unable to convert enough power for the AC load 52, the inverter 54 shuts off and the automatic transfer switch 50 instantaneously shifts the input source to an AC utility power source 48. In one embodiment, the AC power source 48 may be powered from one or more of: a fossil fuel generator, hydroelectric generator, nuclear power generator, renewable energy generator or the like.

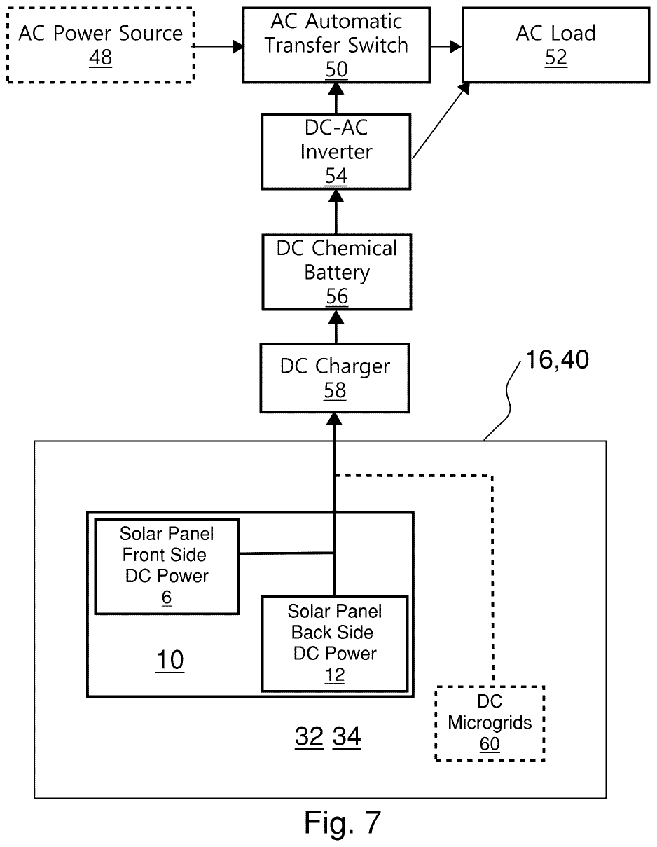

FIG. 7 is an electrical energy diagram of one or more solar panel towers 16 in an array 40 powering an AC load 52 with DC chemical battery 56 and DC charger 58. In some embodiments, the addition of a DC battery 56 and DC charger 58 improves the overall reliability of the power network supporting the AC load 52. In some embodiments, the DC charger 58 is able to adjust the output voltage and current to power one or more DC chemical battery 56. In some embodiments, a DC charger 58 is a maximum power point tracker (MPPT) device. In some embodiments, a DC charger 58 consists of one or more DC power transistors, such as MOSFET, silicon carbide and the like. In some embodiments, a DC chemical battery 56 stores chemical energy which may be converted back to DC electricity. DC electricity may be converted to AC electricity by the DC-AC inverter 54 to directly power one or more AC load 52. In some embodiments, the DC chemical battery 56 has DC fast charging capabilities and may bypass the need for a DC charger 58. In some embodiments, the DC chemical battery 56 requires an external DC charger 58 for fast charging performance.

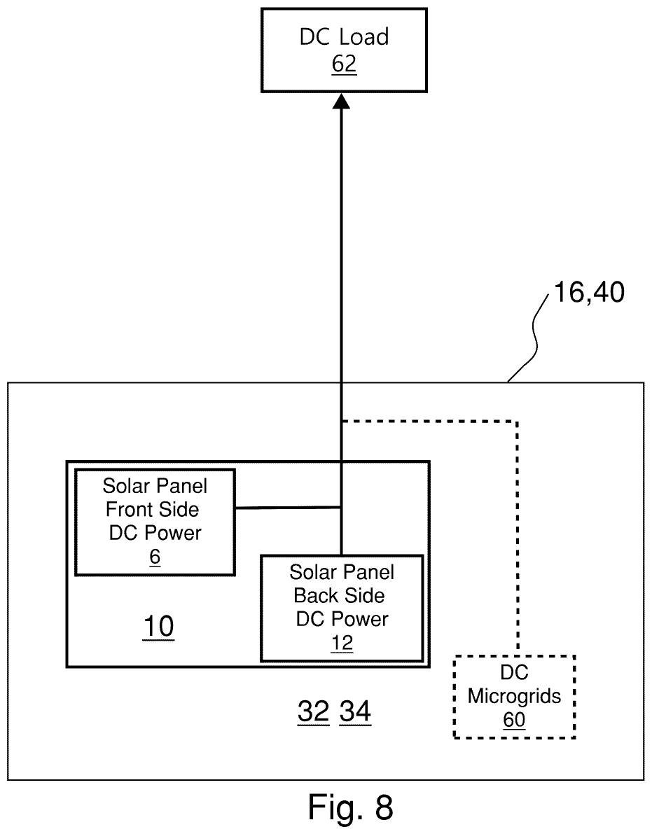

FIG. 8 is an electrical energy diagram of one or more solar panel towers 16 in an array 40 powering a DC load 62. In some embodiments, a DC load 62 may be one or more of resistors, capacitors, inductors, diodes or transistor nodes within a DC power network. In some embodiments, one or more DC load 62 may be powered directly by a solar panel tower 16.

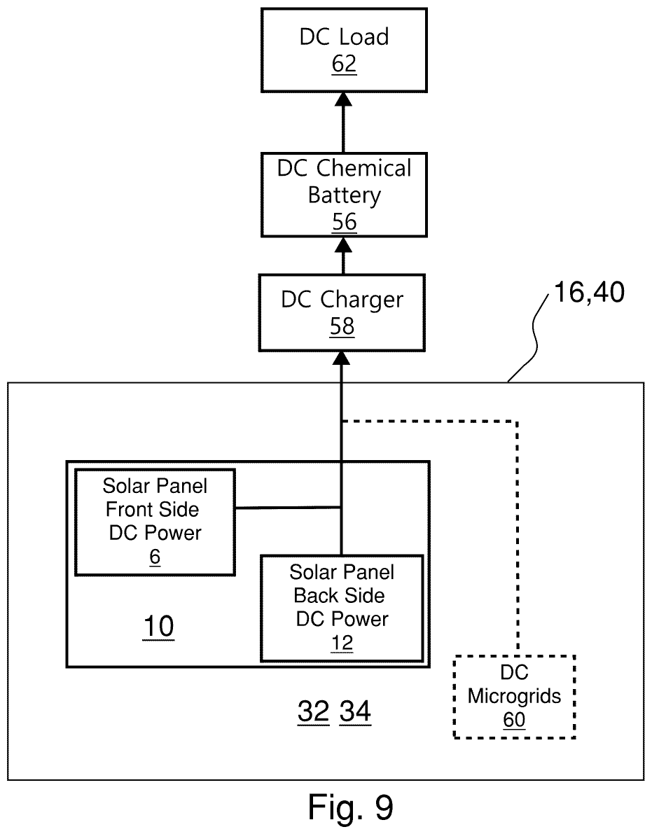

FIG. 9 is an electrical energy diagram of one or more solar panel towers 16 in an array 40 powering a DC Load 62 supported by a DC chemical battery 56 and a DC Charger 58. In some embodiments, the addition of a DC battery 56 and DC charger 58 improves the overall reliability of the power network supporting the DC load 62. In some embodiments, the DC charger 58 is able to adjust the output voltage and current to power one or more DC chemical battery 56. In some embodiments, a DC charger 58 is a maximum power point tracker (MPPT) device. In some embodiments, a DC charger 58 consists of one or more DC power transistors, such as MOSFET, silicon carbide and the like. In some embodiments, a DC chemical battery 56 stores chemical energy which may be converted back to DC electricity to directly power one or more DC load 62. In some embodiments, the DC chemical battery 56 has DC fast charging capabilities and may bypass the need for a DC charger 58. In some embodiments, the DC chemical battery 56 requires an external DC charger 58 for fast charging performance.

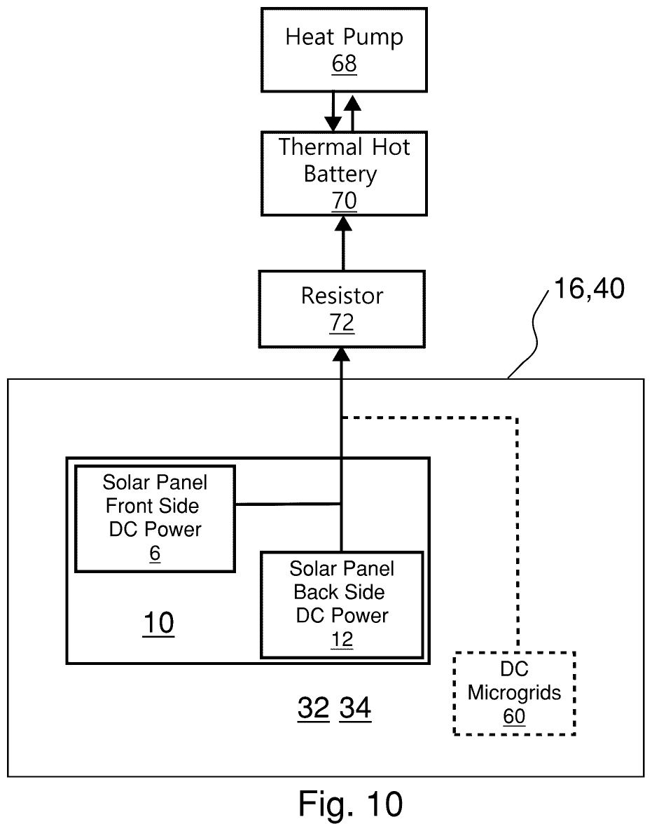

FIG. 10 is an electrical energy diagram of one or more solar panel towers 16 in an array 40 powering a resistor 72 which may output hot thermal energy into one or more hot thermal battery 70 connected to one or more heat pump system 68. In some embodiments, the resistor 72 can be any type of electrical circuit conductor that converts electrical power to thermal energy. In some embodiments, the thermal hot battery 70 may be an insulated container (not shown) that encloses a volume of material with a high specific heat, such as sand or water in thermal isolation. In some embodiments, solar electricity may be stored as thermal energy in the form of heated sand or water for longer duration storage. In some embodiments, the thermal hot battery 70 can be connected to a heat pump system 68 which may circulate a fluid or gas medium (not shown) to transfer thermal heat energy into other systems (not shown).

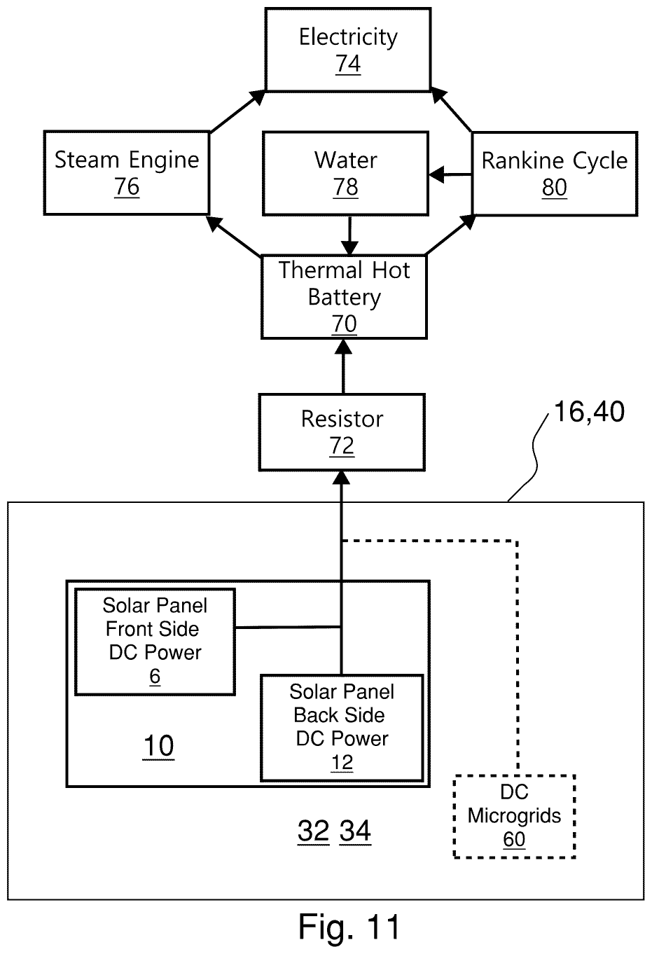

FIG. 11 is an electrical energy diagram of one or more solar panel towers 16 in an array 40 powering a resistor 72 which may output thermal energy into a thermal hot battery 70 connected to one or more steam engine 76 and one or more Rankine cycle 80 turbine to generate electricity 74 from water 78. In some embodiments, liquid water 78 can be evaporated with energy from the thermal hot battery 70 to generate electricity using a steam engine turbine 76. In some embodiments, a Rankine Cycle 80 may recover the water 78 used to generate electricity 74 as a circular byproduct. In some embodiments, an organic Rankine Cycle fluid may be used as an alternative or in addition to water 78. In some embodiments, the resistor 72, thermal hot battery 70, steam engine 76, water 78 and/or Rankine cycle turbine 80 may be contained within a building and/or mobile vehicle such as transport trucks, ocean cargo vessels and aircraft.

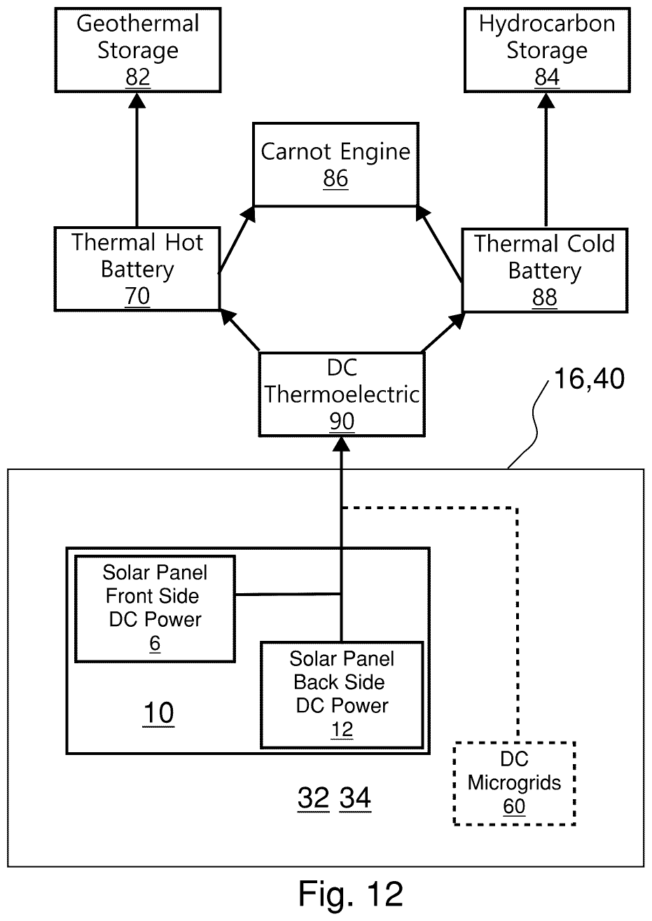

FIG. 12 is an electrical energy diagram of one or more solar panel towers 16 in an array 40 powering a DC Thermoelectric system 90 which may exchange thermal energy with one or more hot thermal battery 70 and one or more cold thermal battery 88. In some embodiments, a DC Thermoelectric system 90 can change from thermal heating to thermal absorption (cooling) by means of reversing the DC polarity within the circuit. In some embodiments, thermal hot batteries 70 and cold batteries 88 may be connected as a Carnot engine 86 to produce thermodynamic work. In some embodiments, one or more thermal hot battery 70 may transfer thermal energy to a geothermal storage 82 system for long term thermal underground storage. In some embodiments, the hot thermal battery 70 and/or underground thermal storage 82 may be contained within a district energy system to supply one or more buildings with thermal energy. In some embodiments, one or more thermal cold battery 88 may absorb thermal energy from a hydrocarbon storage 84 for long term frozen underground storage. In some embodiments, hydrocarbon storage 84 may consist of clathrate hydrates.

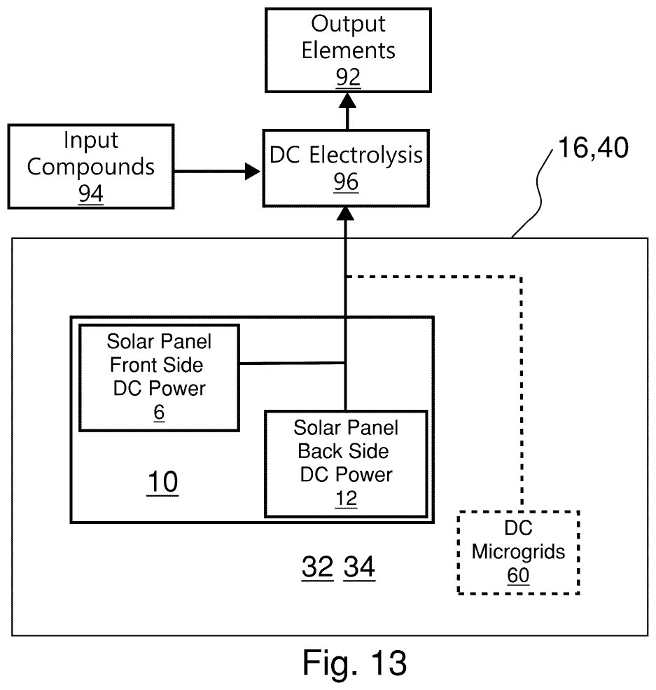

FIG. 13 is an electrical energy diagram of one or more solar panel towers 16 in an array 40 powering a DC electrolysis system 96 which may input one or more chemical compounds 94 and output one or more chemical elements 92.

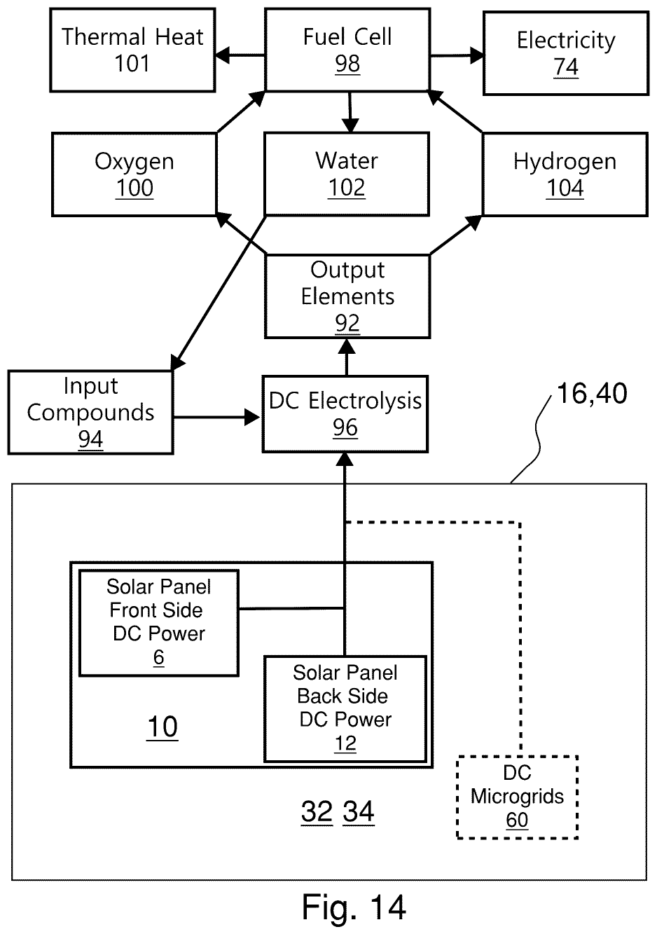

FIG. 14 is an electrical energy diagram of one or more solar panel towers 16 in an array 40 powering a DC electrolysis system 96 which may input chemical compounds 94, like water 102, and output chemical elements 92, like oxygen 100 and hydrogen 104. In some embodiments, the extracted oxygen 100 and hydrogen 102 elements can be combined within a fuel cell 98 to generate electricity 74 and thermal heat 101 with water 102 as a byproduct. The byproduct water 102 can be reused as input compound 94 within a circular DC electrolysis 96 system.

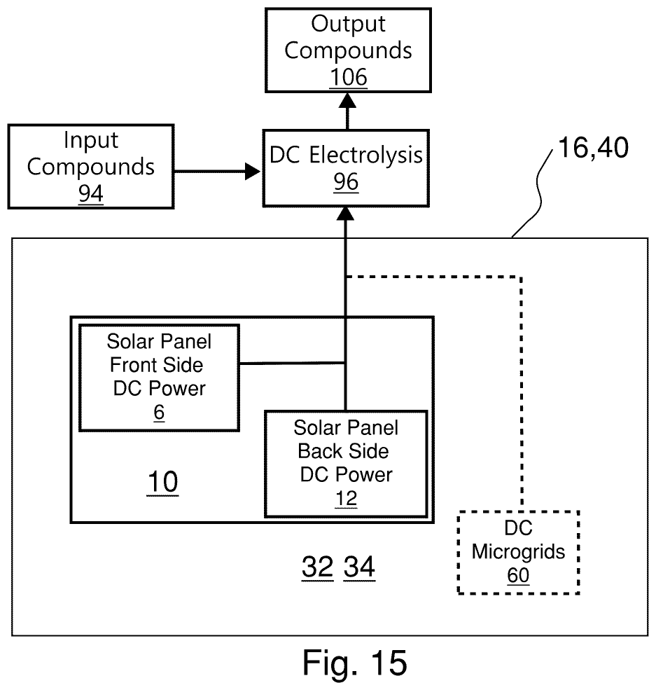

FIG. 15 is an electrical energy diagram of one or more solar panel towers 16 in an array 40 powering a DC electrolysis 96 system which may input one or more chemical compounds 94 and output one or more chemical compounds 106. In some embodiments, a DC Electrolysis 82 system may take one or more hydrocarbons as input compounds 94 and output one or more compound 106 and/or one or more element 92 (not shown).

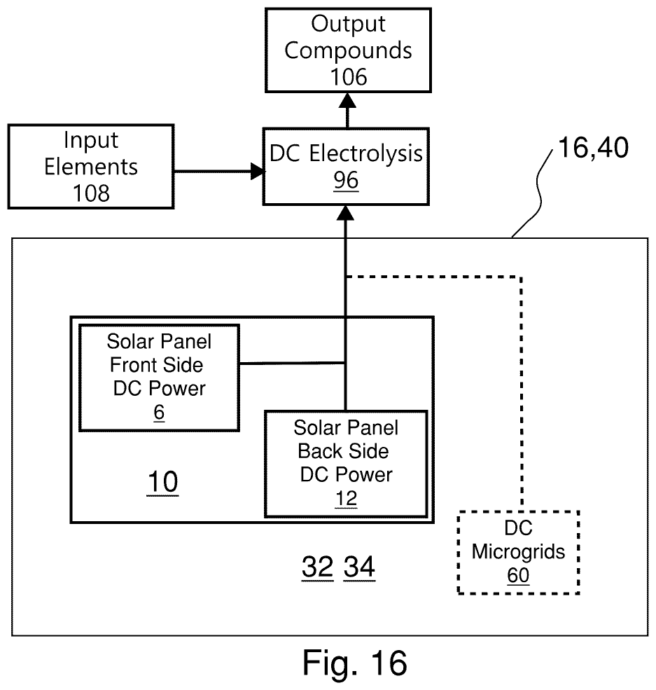

FIG. 16 is an electrical energy diagram of one or more solar panel towers 16 in an array 40 powering a DC Electrolysis system 96 which may input one or more chemical elements 108 and output one or more chemical compounds 106. In some embodiments, Oxygen 100 and Hydrogen 104 may be input elements 108 and water 102 may be an output compound 106.

FIG. 17A is a perspective view of two solar panel towers 16 in an array 40 receiving solar energy directly from the sun, according to an example embodiment. The array 40 shown consists of two adjacent solar panel towers 16 under 4 meters in height with multiple mirrors 42, 44, 46.

FIG. 17B is a perspective view of two solar panel towers 16 in an array 40 receiving reflected solar energy from the sun, according to an example embodiment. The array 40 shown consists of two adjacent solar panel towers 16 under 4 meters in height with multiple mirrors 42, 44, 46.

FIG. 17C is a perspective view of solar panel towers 16 in an array 40 receiving solar energy directly from the sun, according to an example embodiment. The array 40 shown consists of ten adjacent solar panel towers 16 under 61 meters in height with multiple mirrors 42, 44, 46.

FIG. 17D is a perspective view of solar panel towers 16 in an array 40 receiving reflected solar energy from the sun, according to an example embodiment. The array 40 shown consists of ten adjacent solar panel towers 16 under 61 meters in height with multiple mirrors 42, 44, 46.

The volumetric building block simplicity of the solar panel tower 16 encourages the general public to use this invention to achieve clean electricity and energy abundance.

While several embodiments of the invention, together with modifications thereof, have been described in detail herein and illustrated in the accompanying drawings, it will be evident that various further modifications are possible without departing from the scope of the invention. The scope of the claims should not be limited by the preferred embodiments set forth in the examples, but should be given the broadest interpretation consistent with the description as a whole.

### Some Embodiment

Some embodiments of the invention disclosed herein may be developed independently for one or more DC or AC power networks, and later integrated together. Such an approach may enable parallel, dynamic and scalable implementation of the system for one or more buildings or vehicles and the like.

Some embodiments of the invention may be directly connected with one or more electric vehicle charging systems.

Some embodiments of the invention may be augmented with DC renewable power sources 60 like wind and thermoelectric generators (not shown) to generate additional electricity using the shared vertical structure tower area 32 and tower volume 34.

Some embodiments of the invention may power mechanical engineering systems and electrical engineering systems within buildings and/or vehicles and the like.

Some embodiments of the invention may be interconnected to create an adaptable DC power distribution mesh using combinations of wired and/or wireless relationships between towers, buildings, vehicles and devices (not shown).

Some embodiments of the present invention may be used for one or more of the following solar power and/or energy applications:
vehicle charging electrification;
existing building electrification;
construction electrification;
new building electrification;
fossil fuel power plant thermal electrification;
nuclear power plant thermal electrification and/or
hydro power thermal electrification.

Some embodiments of the invention disclosed herein are described using bifacial solar panels 10 within a solar panel tower 16. Some embodiments of the present invention may comprise one or monofacial solar panels 8.

Some embodiments of the present solar panel towers 16 are described in the context of an appurtenance “building”. In one or more embodiments, a “building” may include one or more physically separate solar panel towers, wherein an electrical power network is shared between the separate structures with or without wires.

### Interpretation of Terms

Unless the context clearly requires otherwise, throughout the description and the claims:
“comprise”, “comprising”, and the like are to be construed in an inclusive sense, as opposed to an exclusive or exhaustive sense; that is to say, in the sense of “including, but not limited to”;
“connected”, “coupled”, or any variant thereof, means any connection or coupling, either direct or indirect, between two or more elements; the coupling or connection between the elements can be physical, logical, or a combination thereof;
“herein”, “above”, “below”, and words of similar import, when used to describe this specification, shall refer to this specification as a whole, and not to any particular portions of this specification;
“or”, in reference to a list of two or more items, covers all of the following interpretations of the word: any of the items in the list, all of the items in the list, and any combination of the items in the list;
the singular forms “a”, “an”, and “the” also include the meaning of any appropriate plural forms.

Words that indicate directions such as “vertical”, “transverse”, “horizontal”, “upward”, “downward”, “forward”, “backward”, “inward”, “outward”, “vertical”, “transverse”, “left”, “right”, “front”, “back”, “top”, “bottom”, “below”, “above”, “under”, and the like, used in this description and any accompanying claims (where present), depend on the specific orientation of the apparatus described and illustrated. The subject matter described herein may assume various alternative orientations. Accordingly, these directional terms are not strictly defined and should not be interpreted narrowly.

For example, while processes or blocks are presented in a given order, alternative examples may perform routines having steps, or employ systems having blocks, in a different order, and some processes or blocks may be deleted, moved, added, subdivided, combined, and/or modified to provide alternative or sub-combinations. Each of these processes or blocks may be implemented in a variety of different ways. Also, while processes or blocks are at times shown as being performed in series, these processes or blocks may instead be performed in parallel, or may be performed at different times.

In addition, while elements are at times shown as being performed sequentially as an illustration, they may instead be performed simultaneously or in different sequences. It is therefore intended that the following claims are interpreted to include all such variations as are within their intended scope.

In some embodiments, the invention may be implemented in software as a database model. For greater clarity, “software” includes any instructions executed on a processor, and may include (but is not limited to) firmware, resident software, microcode, and the like. Both processing hardware and software may be centralized or distributed (or a combination thereof), in whole or in part, as known to those skilled in the art. For example, software and other modules may be accessible via local memory, via a network, via a browser or other application in a distributed computing context, or via other means suitable for the purposes described above.

Where a component (e.g. a model, a software module, processor, assembly, device, circuit, etc.) is referred to above, unless otherwise indicated, reference to that component (including a reference to a “means”) should be interpreted as including as equivalents of that component any component which performs the function of the described component (i.e., that is functionally equivalent), including components which are not structurally equivalent to the disclosed structure which performs the function in the illustrated exemplary embodiments of the invention.

Specific examples of systems, methods and apparatus have been described herein for purposes of illustration. These are only examples. The technology provided herein can be applied to systems other than the example systems described above. Many alterations, modifications, additions, omissions, and permutations are possible within the practice of this invention. This invention includes variations on described embodiments that would be apparent to the skilled addressee, including variations obtained by: replacing features, elements and/or acts with equivalent features, elements and/or acts; mixing and matching of features, elements and/or acts from different embodiments; combining features, elements and/or acts from embodiments as described herein with features, elements and/or acts of other technology; and/or omitting combining features, elements and/or acts from described embodiments.

Various features are described herein as being present in “some embodiments”. Such features are not mandatory and may not be present in all embodiments. Embodiments of the invention may include zero, any one or any combination of two or more of such features. This is limited only to the extent that certain ones of such features are incompatible with other ones of such features in the sense that it would be impossible for a person of ordinary skill in the art to construct a practical embodiment that combines such incompatible features. Consequently, the description that “some embodiments” possess feature A and “some embodiments” possess feature B should be interpreted as an express indication that the inventors also contemplate embodiments which combine features A and B (unless the description states otherwise or features A and B are fundamentally incompatible).

It is therefore intended that the following appended claims and claims hereafter introduced are interpreted to include all such modifications, permutations, additions, omissions, and sub-combinations as may reasonably be inferred. The scope of the claims should not be limited by the preferred embodiments set forth in the examples, but should be given the broadest interpretation consistent with the description as a whole.

1. A solar panel tower, the tower comprising:
a first level of one or more bifacial solar panels arranged to form one or more sides of a first polygon around a longitudinal axis, wherein a first face of each of the first level of bifacial solar panels forms one side of the first polygon; and
a second level of bifacial solar panels arranged to form one or more sides of a second polygon around the longitudinal axis and longitudinally spaced along the longitudinal axis from the first level of bifacial solar panels, wherein a first face of each of the second level of bifacial solar panels forms one side of the second polygon.

2. The solar panel tower of claim 1, wherein the first polygon has a number of sides equal to or greater than a number of sides of the second polygon.

3. The solar panel tower of claim 1, wherein the second polygon has a number of sides equal to or less than a number of sides of the first polygon.

4. The solar panel tower of claim 3, further comprising a third level of bifacial solar panels arranged to form one or more sides of a third polygon around the longitudinal axis and longitudinally spaced along the longitudinal axis from the second level of bifacial solar panels, wherein a first face of each of the third level of bifacial solar panels forms one side of the third polygon;
wherein the third polygon has a number of sides equal to, greater than, or less than a number of sides of the second polygon.

5. The solar panel tower of any one of claims 1 to 4, wherein the number of bifacial solar panels in the first level is equal to the number of sides of the first polygon.

6. The solar panel tower of any one of claims 1 to 5, wherein the number of bifacial solar panels in the second level is equal to the number of sides of the second polygon.

7. The solar panel tower of claim 4, wherein the number of bifacial solar panels in the third level is equal to the number of sides of the third polygon.

8. The solar panel tower of any one of claims 1 to 7, further comprising one or more mirrors, wherein a reflective surface of each of the mirrors forms one of the sides of one of: the first polygon and the second polygon.

9. The solar panel tower of claim 4, further comprising one or more mirrors, wherein a reflective surface of each of the mirrors forms one of the sides of one of: the first polygon, the second polygon, and the third polygon.

10. The solar panel tower of any one of claims 1 to 9, wherein the longitudinal axis is substantially vertical.

11. The solar panel tower of any one of claims 1 to 10, wherein the first polygon is a first regular polygon and the second polygon is a second regular polygon.

12. The solar panel tower of claim 4, wherein the first polygon is a first regular polygon, the second polygon is a second regular polygon, and the third polygon is a third regular polygon.

13. The solar panel tower of either of claims 11 and 12, wherein the first polygon is one of: a triangle, a square, a rectangle, a pentagon, a hexagon, a heptagon, an octagon, a nonagon, and a decagon.

14. The solar panel tower of any one of claims 1 to 13, wherein the second level of bifacial solar panels is longitudinally spaced along the longitudinal axis from the first level of bifacial solar panels by a level gap.

15. The solar panel tower of claim 14, wherein the first face of each of the first level and the second level of bifacial solar panels has a panel height parallel to the longitudinal axis, and the level gap is greater than the panel height.

16. The solar panel tower of any one of claims 1 to 14, wherein the sides of the first polygon are substantially parallel with the sides of the second polygon.

17. The solar panel tower of any one of claims 1 to 16, wherein the sides of the first polygon are at an angle to the sides of the second polygon.

18. The solar panel tower of any one of claims 1 to 17, further comprising one or more mirrors configured to reflect sunlight on to one or more of: one or more of the first level of bifacial solar panels and one or more of the second level of bifacial solar panels.

19. The solar panel tower of claim 18, wherein each of the first and the second level of bifacial solar panels has a second face opposed to the first face, and one or more of the mirrors are configured to reflect sunlight on to one or more of: the second face of one or more of the first level of bifacial solar panels and the second face of one or more of the second level of bifacial solar panels.

20. The solar panel tower of either of claims 18 and 19, wherein one or more of the mirrors have a mirrored surface substantially perpendicular to at least one of the second faces of the first level and second level of solar panels.

21. The solar panel tower of any one of claims 18 to 20, wherein one or more of the mirrors have a mirrored surface substantially parallel to at least one of the second faces of the first level and second level of solar panels.

22. The solar panel tower of any one of claims 18 to 21, wherein one or more of the mirrors are configured to reflect sunlight into the exosphere.

23. The solar panel tower of any one of claims 1 to 22, further comprising a support structure connected to the first level and second level of bifacial solar panels and supporting the first level and second level of bifacial solar panels in the tower.

24. The solar panel tower of claim 23, wherein the support structure extends only along the periphery of the solar panel tower.

25. The solar panel tower of either of claims 23 and 24 wherein the support structure is configured to rotate one or both of the first level and the second level of bifacial solar panels around the longitudinal axis.

26. The solar panel tower of any one of claims 23 to 25, wherein the support structure is configured to tilt one or both of the first level and the second level of bifacial solar panels relative to the longitudinal axis.

27. The solar panel tower of any one of claims 1 to 26, wherein an area of the first polygon is less than a sum of the areas of the first faces of the first level and second level of bifacial solar panels.

28. The solar panel tower of any one of claims 1 to 27, wherein two or more of the bifacial solar panels are electrically connected in series.

29. The solar panel tower of any one of claims 1 to 29, wherein two or more of the bifacial solar panels are electrically connected in parallel.

30. The solar panel tower of any one of claims 1 to 29, further comprising an electrical controller, wherein the electrical controller can electrically connect two or more of the bifacial solar panels to an electrical output of the solar panel tower in one of: series, parallel, and a combination of series and parallel.

31. The solar panel tower of claim 30, wherein the electrical output is connected to a load.

32. The solar panel tower of claim 31, wherein the load comprises an alternating current (AC) load.

33. The solar panel tower of claim 31, wherein the electrical output is connected to the AC load by a DC-AC inverter.

34. The solar panel tower of either of claims 32 and 33, wherein the electrical output is connected to the AC load by an automatic transfer switch.

35. The solar panel tower of any one of claims 31 to 34, wherein the load comprises a direct current (DC) load.

36. The solar panel tower of claim 35, wherein the electrical output is connected to the DC load by a DC storage device.

37. The solar panel tower of claim 36, wherein the DC storage device comprises one or more of: a DC chemical battery, and a DC electrolysis system.

38. The solar panel tower of any one of claim 35 to 37, wherein the electrical output is connected to the DC load by a DC charger.

39. The solar panel tower of any one of claims 35 to 38, wherein the DC load comprises a resistor, and the resistor outputs thermal energy.

40. The solar panel tower of claim 39, wherein the thermal energy is stored in a thermal battery.

41. The solar panel tower of either of claims 39 and 40, wherein the thermal energy powers a thermal engine.

42. The solar panel tower of claim 41, wherein the thermal engine comprises one or more of: a steam engine turbine, a Rankine cycle fluid, an organic Rankine cycle fluid, and a Carnot engine.

43. A solar tower array comprising two or more solar panel towers, each according to any one of claims 1 to 42.
